(19) United States
(12) Patent Application Publication
(10) Pub. No.: US 2010/0267581 A1
(43) Pub. Date: Oct. 21, 2010

(54) HIGH THROUGHPUT INTEGRATED MICROFLUIDIC SYSTEM AND DEVICE

(76) Inventors: Urban A. Kiernan, Chandler, AZ (US); Kemmons A. Tubbs, Mesa, AZ (US); Dobrin Nedelkov, Tempe, AZ (US)

Correspondence Address: Zeman-Mullen Law Firm PLLC, 233 White Spar Road, Prescott, AZ, 86303, US

(21) Appl. No.: 12/763,985

(22) Filed: Apr. 20, 2010

Related U.S. Application Data
(60) Provisional application No. 61/170,831, filed on Apr. 20, 2009.

(51) Int. Cl. C40B 30/04; C40B 60/12

(52) U.S. Cl. 506/9; 506/39

(57) ABSTRACT

A microfluidic system and device capable of high throughput which includes a multi-channel micro-column having a high surface area material having at least one affinity reagent bound thereto contained within a housing. The structure of the housing and/or the multi-channel micro-column is of a sufficient size and configuration to enable capture and purification of an analyte contained within a sample and one or more of binding of a reporter molecule to the analyte and a substrate chemical reaction with the analyte to all take place within the housing and/or the multi-channel micro-column.

### CROSS-REFERENCE TO RELATED APPLICATIONS

This application claims the benefit of, and priority to, provisional application Ser. No. 61/170,831, filed Apr. 20, 2009, which application is hereby incorporated by reference in its entirety.

### FIELD OF INVENTION

This invention is related to targeted biomolecule analytics for diagnostic, clinical, R&D or any other field that requires the quantification of a biomolecule from a complex media. Also, the present invention includes the ability to analyze multiple samples at the same time (high throughput) for potential large scale application.

### BACKGROUND OF THE INVENTION

The ability to quantify target biomolecules (e.g. Protein) plays a major role in the areas of basic research, product development, diagnostics and the like. In clinical studies for the regulatory approval of healthcare products, this is a major hurdle due to the large number of analyses required. However, such studies are extremely time consuming and a major financial liability to the entity performing them. The mainstay of biomolecule analytics is achieved through the repetitive large scale application of classical enzyme linked immunosorbent assays (ELISA). This approach is based on the use of affinity ligand capture of a specific target and the subsequent optical detection of an enzymatically converted substrate where the amount of product is proportional to the amount of target analyte within the analyzed sample. However, it is universally recognized that these analyses are a major bottleneck; delaying forward progress and greatly increasing cost. These burdens are also felt by many R&D facilities/departments, during the development and discovery novel products (i.e. therapeutics or diagnostics), which often perform 1000's of ELISA on a daily basis. Therefore, it would be of value to develop a technology and methodology that can streamline this process in a more efficient and cost effective manner while maintaining the analytical specifications and automation of current ELISA approaches.

Other methodologies for biomolecule analytics currently exist. The use of electrophoretic gel technologies (i.e. isoelectric focusing, western blots, etc.) are often employed in basic research and discovery studies, but are not routinely utilized in clinical applications. This is largely due to inconsistencies in the ability to quantify a target, as well as the fact that these processes destroy the native structure of the targets in order to ensure predictable migration. Novel mass spectrometric applications have also recently gained exposure, but most are not amiable to high throughput applications, are unable to resolve the time issues presented, and are not yet economically feasible. Because of this, the ELISA remains the mainstay of such analyses.

As addressed above, the most severe problem associated with ELISA is the time required to perform them. The rate determining step(s) in the classical ELISA are a result of the extended time requirements needed in the incubation phase(s); i.e. for 1) target analyte and reporter molecule capture as well as for 2) the substrate conversion. Typically, these approaches are performed at the macro level in the wells of a micro-titer plate which is available in a variety of special array configurations. Since the affinity interactions mostly rely on Brownian motion for ligand/analyte interaction, the larger the diffusion distance the longer the time required for sufficient capture. For example, the incubation time require for an analyte over a diffusion distance of 1 mm (typical in the size of a standard micro titer plate) is about 1 hour, however if this distance can be truncated to 10-50 □m in length then the incubation time is reduced to ˜3.6 seconds. This same principle is also applicable to the substrate conversion.

The development of micro-fluidic technologies has shown potential to address some of the issues stated above. Preliminary studies with micro-fabricated devices, often referred to as “lab-on-a-chip”, have successfully demonstrated accelerated analyte/ligand incubation times. However, micro-fluidic research in ELISA style applications is severely deficient. The basic premise of these micro-fluidic methods is to flow very small volumes of sample through microscopically etched channels, normally fabricated in silicon or some polymeric support. As the analyte is progressively flowed through the micro-fluidic device it passes through a series of chambers in which it undergoes sequential separation, washing and reaction steps until it is finally detected. The configuration of these devices vary greatly (from compact disc styles to basic planar surfaces) as well as the mechanism for generating continuous flow, but regardless share in this same basic format. The advantage observed in the conversion from a macro to a micro device environment is expedited incubation/reaction times; however, such translations often result in deteriorated analytical sensitivity due to a drastic reduction in the amount of sample analyzed as compared to traditional ELISA. Moreover, the focus in the development of these lab-on-a-chip devices and methods has been towards bench top or point-of-care analyses, not for large scale application (hundreds to tens of thousands of analyses). Because of this drive to develop compact analytical platforms, the optical detection systems for most micro-fluidic methods acquire the measurement of the analyte within the device itself (in a detection chamber). However, such optical measurements are viewed as highly subjective due to a variety of standardization and calibration issues. Conversely, standard spectrophotometer plate readers, utilized in conventional ELISA detection, are well known to take non-subjective measurements. However, no ELISA style micro-fluidics technologies or methods utilize such a detection system.

To date, there are no universal, integrated ELISA style micro-fluidic systems for the high throughput, rapid and non-subjective detection and quantification of biomolecules for the aforementioned reasons. Thus, there is a pressing need for new and novel technologies and methodologies to analyze biomolecules in a state as close to their native environment as possible. Encompassed in these technologies are: 1) the ability to selectively retrieve and concentrate specific biomolecules from complex media for subsequent high-performance analyses in an accelerated fashion, 2) utilizing a micro-fluidic environment for enhanced analyte/affinity ligand interaction, 3) performing enhanced substrate reactions in the same micro-fluidic space as the affinity capture, 4) the ability to detect and quantify the target analyte with a non-subjective detection system and 5) being able to perform high throughput analyses for the large scale screening of populations of samples using a single, economical platform.

### SUMMARY OF THE INVENTION

It is an objective of the present invention to provide an integrate micro-fluidic system that is capable of selectively retrieving and concentrating selected biomolecules from complex media for subsequent high-performance analyses, perform non-subjective quantification of the target analyte and have the ability to perform high throughput screening of large populations using a single, unified, economical and parallel processing platform.

It is another objective of the present invention to provide individual components for the integrated system that comprises a micro-fluidic device (with a dual functionality as a molecular trap/reaction chamber), such as monolithic solid supports with a plurality of etched micro-fluidic channels, processing stations, non-subjective detectors, and a robotic flow system with process/data analysis interactive data software that accomplishes the high throughput analyses.

It is a further objective of the present invention to provide a high throughput embodiment of the present invention that uses robotics for serial preparation and parallel processing of a large number of samples simultaneously.

It is yet a further objective of the present invention to provide methods and processes for use of individual components and the integrated system in applications.

The novel features that are considered characteristic of the invention are set forth with particularity in the claims. The invention itself, however, both as to its structure and its operation together with the additional objectives and advantages thereof will best be understood from the following description of the preferred embodiment of the present invention when read in conjunction with the accompanying drawings. Unless specifically noted, it is intended that the words and phrases in the specification and claims be given the ordinary and accustomed meaning for those of ordinary skill in the application of the art or arts. If any other meaning is intended, the specification will specifically state that special meaning is being applied to the word or phrase. Likewise, the use of the words “function” or “means” in the Description of Preferred Embodiments is not intended to indicate a desire to invoke the special provisions of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include all structures, materials or acts that perform the claimed function, along with any known or later-developed equivalent structures, materials or acts for performing the claimed function.

### BRIEF DESCRIPTION OF THE DRAWINGS

FIG. 1 is an illustration of the workflow utilized in the micro-fluidic sandwich ELISA procedure performed in conjunction with the integrated micro-fluidic system and device of the present invention. Analytes and reporter molecule conjugated detection affinity ligand are selectively retrieved from solution. This is achieved by sequentially flowing the sample and detection affinity ligand solution through the multi-channel affinity micro-column. Sufficient washing takes place between each step to remove non-specifically bound compounds. Substrate solution is then flowed through the micro-column for the enzymatic reporter molecule reaction. After incubation, the reacted substrate fluid is then expelled from the micro-fluidic device into the well of a micro-titer plate for subsequent spectrophotomic detection.

FIG. 2 is an illustration of the workflow utilized in the micro-fluidic competitive ELISA procedure performed in conjunction with the integrated microfluidic system and device of the present invention. Sample solution that has been spike with an enzyme conjugated analogue of the target analyte is flowed through the multi-channel affinity micro-column. The analogue and the endogenous analyte compete for binding to the affinity ligand that is bound within the micro-channels the device. Washing steps take place to remove non-specifically bound compounds and then substrate solution is flowed though the micro-column, resulting in the enzymatic reporter molecule reaction. The reacted substrate is then expelled from the micro-fluidic device into the well of a micro-titer plate for subsequent spectrophotomic detection.

FIG. 3 is an illustration of the workflow utilized in the micro-fluidic assay procedure for the capture of an analyte which also serves as the reporter molecule due to its innate enzymatic activity performed in conjunction with the integrated microfluidic system and device of the present invention. The sample solution is flown through the micro-fluidic device and the target analyte is captured in the process. Washing steps then take place to remove non-specifically bound compounds followed by the exposure to substrate solution. The bound analyte has enzymatic properties and results in the enzymatic reporter molecule reaction. The reporter molecule product is then expelled from the micro-fluidic device into the well of a micro-titer plate for subsequent spectrophotomic detection.

FIG. 4 is the working curve generated from the application of a RBP4 micro-fluidic sandwich ELISA on manufactured calibrant samples. The RBP4 concentrations ranged from 0.0 to 165 mg/L.

Table 1 is the quantitative RBP4 screening of a control and multiple human plasma samples. The RBP4 micro-fluidic sandwich ELISA protocol was applied to samples and the optical measurements were quantified using the previously described working curve. Plasma sample 4 was run twice, once in the normal fashion and once with a 2× volume. As expected, the 2× volume re-run produced results that were approximately twice as high as the original run.

### DETAILED DESCRIPTION

The present invention provides an integrated high throughput system capable of selectively retrieving and concentrating specific biomolecules from complex media for subsequent high-performance analyses, such as detection of target biomolecules, quantifying target biomolecules, and high throughput screening of large populations of samples using a single, unified, economical, and parallel processing platform.

The preferred embodiment of the integrated system comprises a micro-fluidic device (serving a dual function as a molecular trap/reaction chamber), such as monolithic solid supports with a plurality of etched micro-fluidic channels for these functions, processing stations that work with detection devices and using processing/data analysis interactive data software that accomplishes the high throughput analyses. The present invention also includes methods and processes for use of the individual components and the integrated system in applications. Furthermore, the preferred embodiment of the present invention provides for the preparation and/or processing of multiple separate devices and/or samples to accomplish high throughput analysis.

The molecular trapping component of the present invention involves the isolation or retrieval of specific analytes from their surrounding complex media. This is accomplished using the micro-fluidic device serving the function as a molecular trap. In a preferred embodiment of the molecular trap, the retrieval process entails flowing of the sample through a multi-channeled micro-fluidic column contained within a housing. Flowing may include, but is not limited to; repetitive or continuous flow. The immobilized affinity ligands are located within the high surface area content channels of a micro-column. Immobilized affinity ligands may include, but are limited to; antibodies, aptamers, nucleotides, small molecules, etc. This produces a high concentration of affinity ligands within a very small physical volume. The affinity ligands are selected to capture specific analytes. In the high throughput embodiment, these molecular traps are formed into miniature monolithic columns (affinity micro-columns) that are etched with a plurality of micro-channels within them that work in chorus. This compact format thereby allows for numerous affinity micro-columns to be located side-by-side contained within a unitary component, such as a manifold or block of material. In this form the manifold contains numerous individual flow apparatuses that house the affinity micro-columns to serve initially as molecular traps. The housing for the micro-columns can include, but is not limited to, pipette tips, tubing, capillaries, and the like. Moreover, the housing comprises a structure that is capable of enabling both capture and purification of an analyte as well as one or more of a reporter molecule binding to the analyte or a substrate chemical reaction with the analyte to take place within the housing. The housing is of a sufficient size and configuration to enable all of these processes to be carried out within the housing or within the multi-channeled micro-fluidic column contained within the housing.

The molecular trapping process works by allowing sufficient physical contact between the affinity ligands located in the micro-fluidic channels and the analyte in the complex sample. Interactions for molecular trapping are enhanced by the micro-environment created by the micro-channels within each affinity micro-column, and are yet further enhanced by having a plurality of said micro-channels working together within a single micro-column device. During this trapping phase, or incubation, the affinity ligands capture, or isolate, the specific analytes using affinity interactions between the affinity ligand and the specific analytes. After the specific analytes are captured, residual or non-captured components are washed free of the molecular traps using a series of rinses. The capture and rinse processes result in the concentration of the target analytes in the micro-channels of the devices.

In an embodiment of this invention the assay protocol involved is in a “sandwich” format, in which a molecular “scaffold” within the channels of the micro-fluidic device is assembled. Assembly involves the sequential trapping of additional affinity ligands with the eventual retention of an affinity ligand conjugated reporter molecule. These scaffolds are built upon the affinity captured analyte from the sample. Subsequent molecular trapping is performed using the aforementioned protocol, except it substitutes the incubation of sample with a solution of an additional affinity ligand. Capture of the detection affinity ligand follows the same principles as the isolation of the target analyte. The scaffold assembly may utilize sequential incubations in the addition of several affinity ligand layers, such as; secondary or tertiary affinity ligands, streptavidin/biotin systems, and the like. Regardless, the terminal affinity ligand used in a sandwich assay is labeled with a reporter molecule. Analyte measurements are the result of the detection of product from the conversion of substrate by the reporter molecule. The reaction of the reporter molecule occurs in the same micro-fluidic channel space that was used for molecular trapping.

In another embodiment, the present invention utilizes a competitive assay format. This process involves the spiking of the sample to be analyzed with an analogue of the target biomolecule with an enzyme conjugate. The molecular trapping process for the competitive assay is not different from the aforementioned protocol. During the sample incubation, the spiked analogue competes with the endogenous analyte for binding to the affinity ligand and both are co-captured in a single trapping step. Analyte detection is the result of the measurement of the amount of product produced resulting from the enzymatic reaction of a substrate. The enzymatic reaction takes place in the same micro-fluidic channels as the molecular trapping.

In yet another embodiment, the present invention involves the capture of an analyte, which has enzymatic activity, from a complex solution. This is accomplished in a single trapping step, using the same protocol as described above. Detection involves measuring the amount of product produced from the enzymatic action of the bound analyte to convert a substrate. This reaction also takes place in the same micro-fluidic channels used for the molecular trapping.

In all cases the principles behind the substrate conversion are similar to affinity capture, in that the substrate must interact with the reporter molecule/modifying enzyme for the reaction to occur. The truncated diffusion distance created by the micro-environment within the micro-fluidics results in the same benefits as observed in the trapping phase over conventional plate based ELISA methods. As with standard ELISA analyses, the amount of converted product produced in the micro-channels of the device can be related back to the concentration of analyte within the analyzed sample.

In the preferred embodiment, the detection of the substrate product occurs peripheral to the micro-fluidic device, utilizing standard detection devices; including but not limited to; UV/Vis, fluorescence, mass spectrometry, etc.

The high throughput embodiment of the present invention uses robotics for serial preparation and parallel processing of a large number of samples. The use of affinity micro-columns in capturing the specific analytes enables an arrayed format, as mentioned above, that is ideal for such high-throughput processing since it minimizes the physical volume and/or area occupied by the micro-column array. Use of micro-fluidic affinity micro-columns with appropriately configured robotics allows multiple samples to be prepared, processed, start-to-finish, simultaneously on a unified platform thereby enabling high throughput of samples. Specifically, all capture, separation and substrate conversion steps are performed within the plurality of micro-channels within each micro-column managed by the robotics system or systems. This is in contrast to the use of other affinity capture methods (using, e.g., beaded media) where mechanical/physical means (e.g., centrifugation, magnetic or vacuum separation) are used to separate the specific analyte from the biological fluid and rinse buffers. Oftentimes this physical separation needs to be performed singularly, resulting in the disruption of a parallel processing sequence, as well as the ordering of the array. Because these mechanical/physical means are not necessary when using the micro-columns, parallel-processing sequences can be used without disruption and the integrity of an ordered spatial array is maintained throughout the entire process. Most conveniently, multiple preparations/analyses are performed serially and in parallel using robotics fitted to commonly used spatial arrays, e.g., 4-, 8-, 16-, 48-, 96-, 384 or 1536 well micro-titer plate formats.

### Individual Components

In all of the below described embodiments, it may be desired that the complex media or the target analyte be modified or prepared either prior to affinity action or after affinity capture, but before the reaction for substrate conversion. Example modifications or preparations include, but are not limited to, reduction, labeling or tagging, in situ digests, partial on-surface digestion/modification, pH adjustments, and the like.

### Molecular Traps/Reaction Chamber

In one embodiment of the invention, multi-channel columnar micro-fluidic devices that have bound affinity ligands, serve the dual role as molecular traps and reaction chambers. The micro-fluidic device is chemically modified, such as by treatment with an amino-silanization reagent and subsequently activated for affinity ligand linkage using any one of a number of derivatization schemes. The use of affinity micro-columns overcomes the disadvantages entailed in performing ELISA style analyses by other means. Specifically, the multi micro-channel affinity micro-columns, as described herein, capitalize on micro-fluidic principles that have only emerged in the last twenty years. Prior to the development of “lab-on-a-chip” type applications, immunoassay applications had been primarily performed on a macro level; a time, labor and cost intensive process. Given the fact that the substrate conversion into detection product augments the sensitivity of the assay, the entire assay process, including devices can be scaled down by several orders of magnitude. Moreover, since detection takes place peripherally to the micro-fluidic device; standard non-subjective detection devices may be employed.

### High Throughput Machine

The individual components described herein come together to form a single, integrated system capable of high-throughput analysis of analytes retrieved from crude media. The present invention is used in the high throughput quantitation of specific analytes present in such crude media. Using this process, analytes are retrieved from the sample and subsequently optically detected by means of an enzyme converted substrate. In the same parallel assaying operation, standard samples are analyzed to produce working curves equating analyte signal with the amount of analyte present in the media. The amount of analyte present in each sample can then be either judged as elevated relative to other samples, or determined absolutely using the working curve.

In a further embodiment, protein-ligand interactions are investigated by designing an affinity reagent to target a specific protein that in itself retains other analytes. In this manner, protein complexes are retrieved from biological media by targeting one of their constituents. Once isolated, one of the protein complex constituents is then targeted by a detection affinty ligand using the aforementioned analytical approach. The identity and nature of the components of the complex are then delineated.

Specific embodiments in accordance with the present inventions will now be described in detail. These examples are intended to be illustrative, and the invention is not limited to the materials, methods or apparatus set forth in these embodiments.

### Applications

### Example

### Retinol Binding Protein 4 (RBP4) Analysis from Plasma

### Micro-Fluidic Analysis

Described is an example of the detection and quantification of a biomolecule using the described invention. In this study, the analysis of the biomolecule Retinol Binding Protein 4 (RBP4) was performed, but can be applied to any other analyte of interest. Each RBP4 antibody deritivitized affinty micro-column was housed in a micro-pipette format. Assays can be performed individually or in a plurality through the integration of a parallel processing manifold. This example used a robotic pipetting workstation outfitted with multiple micro-fluidic pipette format affinity devices for high throughput analysis.

The analyte containing sample used in this example was human plasma, although other complex media may be used. Samples were diluted 1/1000 in diluent buffer, which was 10 mM HEPES buffered saline at pH 7.4, with 0.15 M NaCl, 50 mM EDTA and 0.005% Surfactant P20 (HBS-EP). One sample was analyzed twice, with the second analysis using twice the sample volume as the original run. Calibrant samples were prepared by making serial dilutions of purified human RBP4 with known concentration in the diluent buffer. A total of five calibrants were prepared which had final concentrations that range from 0.0 to 165 mg/L. A control sample was prepared in the same fashion as the calibrants but at a final concentration of 7.5 mg/L. Final volumes for the analyzed samples were 200 □L. Each sample was aliquoted in its own well of a 96-well micro-titer plate.

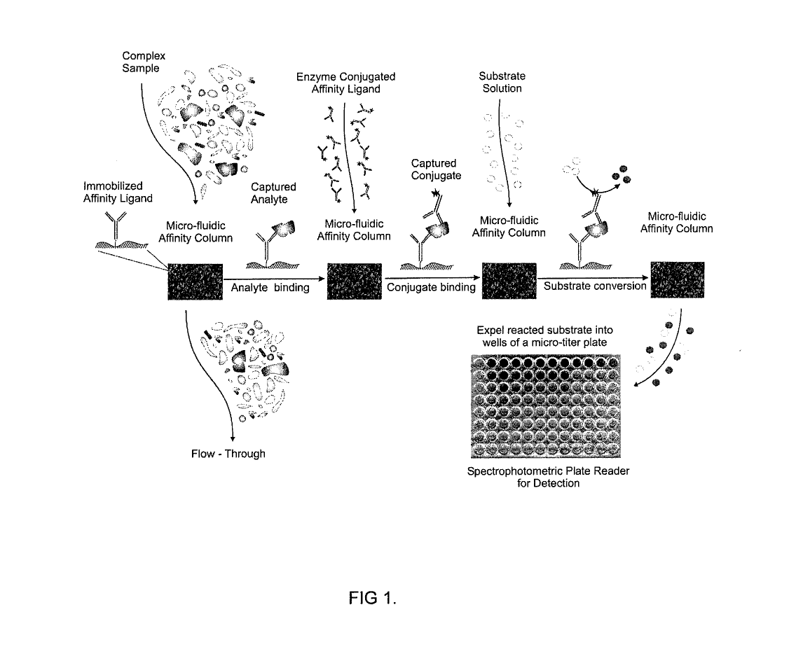

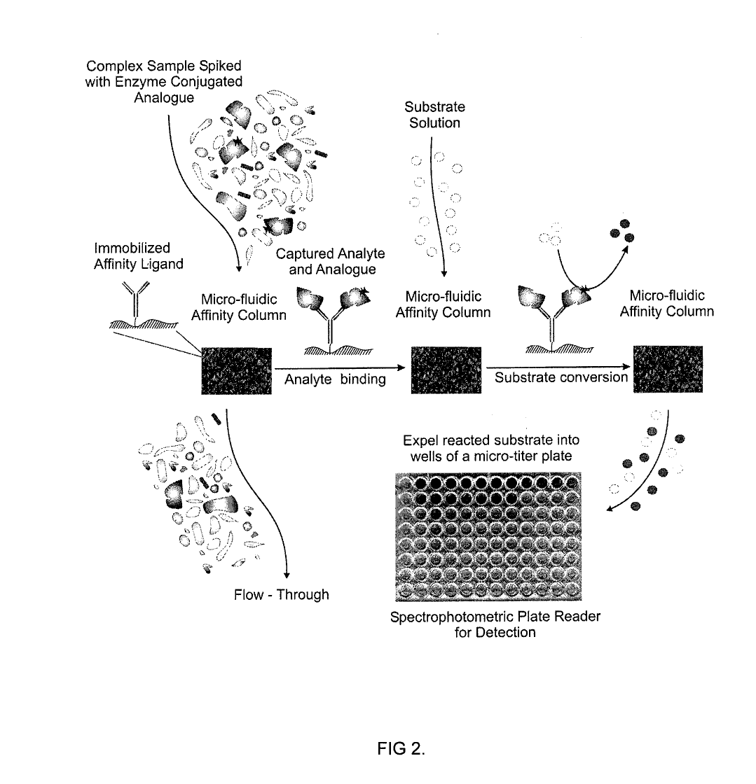

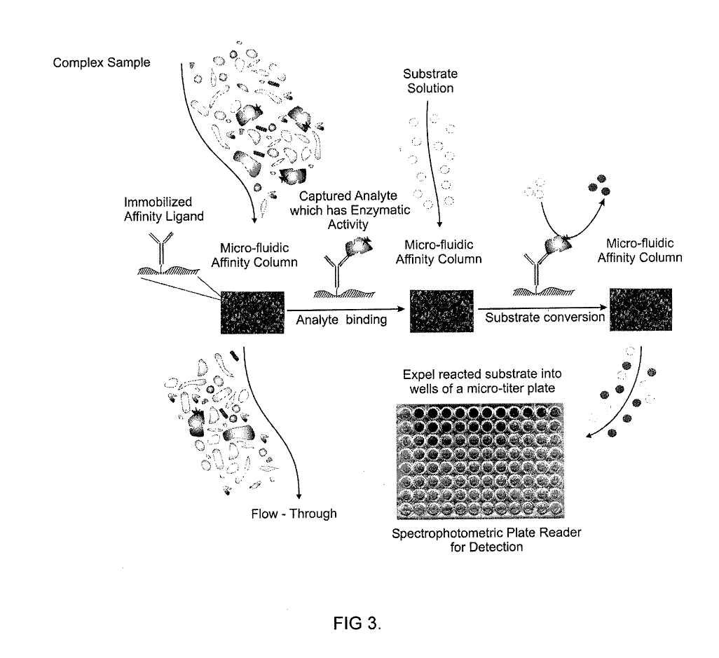

In this example, the assay performed was in a sandwich style as described in FIG. 1. Another assaying format is competitive, as illustrated in FIG. 2. The other assaying format in the preferred embodiment involves the capture of analyte that possesses enzymatic activity and thus used to react substrate. This format is described in FIG. 3.

In this example, the RBP4 detection was done with an individual pipette-tip housed affinity micro-column for each sample analysis. In the assay process, analyte was trapped by the immobilized affinity ligands as sample was repeatedly drawn through the micro-fluidic device (200 times) through the action of the pipetting workstation for analyte incubation. After the repetitive-flow incubation, the capture analyte was rinsed with HBS-EP in the same type of repetitive flow process (20 draws). The next step in the assay involved the incubation of the captured analyte, within the channels of the micro-columns, with secondary RBP4 antibody. This second molecular trap incubation was done with 200 repetative draws. This secondary antibody is conjugated with a reporter molecule, in this example being horseradish peroxidase (HRP). After subsequent HBS-EP and water rinse step (20 draws each). The resultant assembled molecular scaffolds are then exposed (repetative flow) to substrate solution. The substrate used in the example was 3,3′,5,5′-tetramethylbenzidine (TMB). Incubation of the substrate for reporter molecule reaction lasted five minutes. After the substrate reaction period, an aliquot of the developed substrate, 150 □L, was expelled from the micro-fluidic devices into individual wells of a micro-titer plate for subsequent peripheral detection. Each well of the micro-titer plate was preloaded with 50 □L of acid stop solution. The detection device used was a UV/Vis plate reader using a 450 nm minus a 620 nm wavelength. Total time to perform analyses was less than 25 minutes, where as the equivalent micro-titer plate based RBP4 ELISA is performed on the order of 2.5 hours.

### Quantification

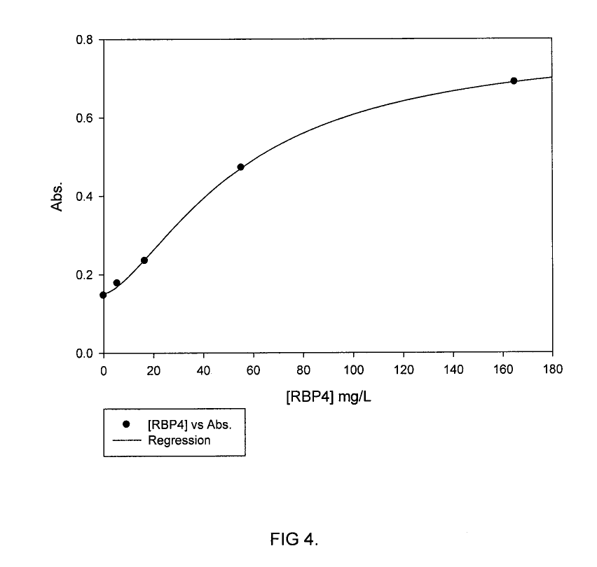

The amount of target analyte within each sample was quantified using a working curve. Calibrants were simultaneously processed as the plasma and control samples and the resultant absorbance readings from the calibrants were then plotted. The plot, working curve, was then characterized by linear regression and a line equation was determined. This plot is shown in FIG. 4. The established regression line equation was then used to calculate the sample concentration from their respective absorbance readings. The calculated concentrations from the RBP4 sample analyses are shown in TABLE 1. The measured concentration of the control was very close to the theoretical concentration (8.32 vs 7.5 mg/L, respectively). The RBP4 plasma values measured were all within the literature reported range for this biomolecule. Sample 4 was run twice, with the second run using twice the volume of sample as the first run. As expected, the measurements of the second run were approximately twice that of the original.

As used herein, “micro-column” are miniature high surface area monoliths that are etched with a plurality of micro-channels within them. They are contained within a housing to be used as a micro-fluidic device in which the etched channels work in chorus.

As used herein, “affinity ligand” refers to a chemical species that is able to bind an analyte present in a complex media. Affinity ligands may be organic, inorganic or biological by nature, and can exhibit broad (targeting numerous analytes) to narrow (target a single analyte) specificity. Examples of affinity ligands include, but are not limited to, antibodies, antibody fragments, synthetic paratopes, peptides, polypeptides, enzymes, proteins, multi-subunit protein receptors, mimics, organic molecules, polymers, inorganic molecules, chelators, nucleic acids and aptamers.

As used herein, “affinity micro-column” refers to a micro-column in which affinity ligand has been immobilized within its plurality of micro-channels.

As used herein, “complex media” refers to a fluid or extract having a plurality of components. Complex media may include, cell extracts, nuclear extracts, cell lysates and excretions, blood, sera, plasma, urine, sputum, sinovial fluid, cerebral-spinal fluid, tears, feces, saliva, membrane extracts, industrial fluids and the like.

As used herein, “analyte” refers to biomolecules of interest present in a sample. Analytes may be, but are not limited to, nucleic acids (DNA, RNA), peptides, hormonal peptides, hormones, polypeptides, proteins, protein complexes, carbohydrates or small inorganic or organic molecules having biological function. Analytes may naturally contain sequences, motifs or groups recognized by the affinity receptors or may have these recognition moieties introduced into them via processing such as cellular, extracellular, enzymatic, chemical, and the like.

As used herein “molecular trap” refers to the capture of analyte or affinity ligand within the channels of the affinity micro-column.

As used herein “reporter molecule” refers to an affinity ligand conjugated with a molecule that is enzymatically able to convert a substrate into a product for subsequent detection.

As used herein “enzyme conjugate” refers to the covalent modification of a molecule, analyte or affinity ligand, with an enzyme that is able to convert a substrate into a product for subsequent detection. Enzyme conjugates may include, but not limited to, horse radish peroxidate, alkaline phosphotase, b-galactosidase, acetylcholinesterase and the like.

As used herein “substrate” refers to a solution containing a molecule that is converted by the enzyme conjugate into a product which is then subsequently detected. Substrates may include, but are not limited to, 3,3′,5,5′-tetramethylbenzidine (TMB), 2,2′-azino-di(3-ethylbenzthiazoline-6-sulfonate (ABTS), luminol and its derivatives, para-nitrophenylphosphate (pNPP), 5-bromo-4-chloro-3-indoyl phosphate (BCIP), Fluorescein mono-β-D-Galactopyranoside and the like.

As used herein “reaction chamber” refers to the location within the micro-fluidic device in which the conversion of the substrate takes place. The reaction chamber in this invention is the same physical space within the channels of the affinity micro-columns that the molecular trapping takes place.

As used herein, “detection device” refers to a device able to take a measurement of the reacted substrate product. Suitable detection devices include, but are not limited to; Mass Spectrometry, UV/Vis spectrophotometers, fluorescence readers and the like.

As used herein, “robotics” refers to devices and procedures capable of the unattended processing of samples. Preferably, the robotics operate on numerous samples in parallel to maximize the number of samples processed and analyzed in a given amount of time.

The preferred embodiment of the invention is described above in the Drawings and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventors that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration, and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

1. A method for selectively measuring an analyte comprising the steps of:
a) providing a multi-channel micro-column having a high surface area material having at least one affinity reagent bound thereto contained within a housing;
b) flowing a sample containing an analyte through the multi-channel micro-column to bind the analyte to the affinity reagent on the high surface area material;
c) applying a solution containing a reporter molecule to the high surface area material to enable binding to the analyte to take place within the same multi-channel micro-column housing; and
d) detecting the result of the reporter molecule binding.

2. The method of claim 1 wherein the reporter molecule is an enzyme-affinity conjugate reagent that binds to the analyte within the multi-channel micro-column housing.

3. The method of claim 2 wherein a substrate solution is applied to the multi-channel micro-column to enable a chemical reaction to take place with the enzyme-affinity conjugate reagent contained within the housing.

4. The method of claim 3 wherein the chemical reaction of the substrate with the enzyme-affinity reagent conjugate is detected.

5. The method of claim 1 wherein the housing is at least one of a micropipette or a manifold having more than one dimension.

6. The method of claim 1 wherein one or more of steps a) through d) are automated with the assistance of a robotics system.

7. A method for selectively measuring an analyte comprising the steps of:
a) providing a multi-channel micro-column having a high surface area material having at least one affinity reagent bound thereto contained within a housing;
b) flowing a sample containing an analyte through the multi-channel micro-column to bind the analyte to the affinity reagent on the high surface area material;
c) applying a substrate to the high surface area material to enable chemical reaction with the analyte to take place within the same multi-channel micro-column housing; and
d) detecting the result of the chemical reaction.

8. A method for selectively measuring an analyte comprising the steps of:
a) providing a multi-channel micro-column having a high surface area material having at least one affinity reagent bound thereto contained within a housing;
b) flowing a sample containing an analyte and an analyte-enzyme conjugate through the multi-channel micro-column to bind the analyte and analyte-enzyme conjugate to the affinity reagent on the high surface area material;
c) applying a substrate to the high surface area material to enable chemical reaction with the analyte-enzyme-conjugate to take place within the same multi-channel micro-column housing; and
d) detecting the result of the chemical reaction.

9. A device for selectively measuring a substance wherein the device comprises a housing containing a multi-channel microcolumn having a high surface area material having at least one affinity reagent bound thereto, wherein the structure of the housing enables capture and purification of an analyte contained within a sample and a reporter molecule binding to the analyte to all take place within the housing.

10. The device of claim 9 wherein the reporter molecule is an enzyme-affinity conjugate reagent that binds to the analyte within the multi-channel micro-column housing.

11. The device of claim 10 wherein a substrate solution is applied to the multi-channel micro-column to enable a chemical reaction to take place with the enzyme-affinity conjugate reagent contained within the housing.

12. The device of claim 11 wherein the chemical reaction of the substrate with the enzyme-affinity reagent conjugate is detected.

13. The device of claim 9 wherein the housing is at least one of a micropipette or a manifold having more than one dimension.

14. A device for selectively measuring a substance wherein the device comprises a housing containing a multi-channel microcolumn having a high surface area material having at least one affinity reagent bound thereto, wherein the structure of the housing enables capture and purification of an analyte contained within a sample and a substrate chemical reaction with the analyte to all take place within the housing.

15. The device of claim 14 wherein the housing is at least one of a micropipette or a manifold having more than one dimension.

16. A device for selectively measuring a substance wherein the device comprises a housing containing a multi-channel microcolumn having a high surface area material having at least one affinity reagent bound thereto, wherein capture and purification of an analyte and analyte-enzyme conjugate contained within a sample, and a substrate chemical reaction with the analyte-enzyme conjugate all take place within the housing.

17. The device of claim 16 wherein the housing is at least one of a micropipette or a manifold having more than one dimension.

18. A system for selectively measuring an analyte comprising:
a multi-channel microcolumn having a high surface area material having at least one affinity reagent bound thereto contained within a housing wherein a plurality of steps including capture and purification of an analyte and or analyte-enzyme conjugate contained within a sample, and reporter molecule binding to the analyte or chemical reaction of a substrate with the reporter molecule or the analyte or the analyte enzyme-conjugate all take place in the housing;
a solution basin having a plurality of wells for receiving any solution resulting from the chemical reaction of the substrate with the reporter molecule or the analyte or the analyte enzyme-conjugate; and
a detector for detecting and measuring the resulting chemical reaction in solution.

19. The system of claim 18 wherein the housing is at least one of a micropipette or a manifold having more than one dimension.

20. The system of claim 19 wherein one or more elements and/or steps contained within the system are automated with the assistance of a robotics system.
